(19) United States
(12) Patent Application Publication
(10) Pub. No.: US 2023/0136974 A1
(43) Pub. Date: May 4, 2023

(54) UPSIDE-DOWN PUMP

(71) Applicant: YUYAO AOHONG PLASTIC INDUSTRY CO., LTD, Yuyao City (CN)

(72) Inventor: Honghu HUANG, Yuyao City (CN)

(73) Assignee: YUYAO AOHONG PLASTIC INDUSTRY CO., LTD, Yuyao City (CN)

(21) Appl. No.: 17/943,740

(22) Filed: Sep. 13, 2022

(30) Foreign Application Priority Data
Oct. 28, 2021 (CN) 202111262810.0

(51) Int. Cl. B05B 7/00; B05B 11/00

(52) U.S. Cl. CPC B05B 7/0056; B05B 11/3092; B05B 11/3043

(57) ABSTRACT

An upside-down pump wherein the pump core assembly includes outer and inner pump bodies, the center hole of the piston in the inner pump body adjoins a connecting rod, which fits with the liquid inflow cavity and the outer diameter includes a spring, the outer diameter ring of the valve sleeve includes a side thru-hole, the inner diameter bottom hole of the inner pump includes a second ball and extends from the suction pipe hole on one side of the external pump and fits with the first thru-hole on one side of the connecting sleeve and has an annular clearance, the second thru-hole opposite the first fits with one end of the pipe, the coupling joint has a first ball, the bottom of the connecting sleeve has a base sleeve, the knurled column is inserted into the auxiliary hole in the external pump with a gap, and the thru-holes communicate.

### TECHNICAL FIELD

The present invention relates to a miniaturized foaming pump, specifically an upside-down pump.

### BACKGROUND ART

Foaming pump is a sort of pump that can eject out foam. By purpose of use and size, it is generally classified into industrial foaming pump, firefighting foaming pump, and miniaturized foaming pump. How a miniaturized foaming pump works: ejects out liquid at a high speed to produce a certain negative pressure around the liquid column, which draws air into the mixture portion, so that air and liquid will mix again and travels through the screen mesh fast, until foam can be formed. However, these products and like products can be used in an upside-down state, or the liquid in container can be used up; for example, the patent application number 201810003336.1 as disclosed in the Chinese patent literature, the publication date 2018 Jun. 29, the utility model title “A foaming pump that can eject liquid in an upside-down state”; another example is the patent application number 201810003310.7 as disclosed in the Chinese patent literature, the publication date 2018 Jun. 15, the patent title “An upside-down squeezing foam pump”. However, the upside-down spraying structure of the above products and like products is principally fit with a straight-through single-ball reverse spraying valve or tee junction double-ball reverse spraying, the stability of the pump core assembly is poor, and the pressure in the pump core assembly is hard to stabilize. As a consequence, the liquid spraying effect, especially the foam spraying effect is poor,

### SUMMARY OF THE INVENTION

To address the deficiencies as described above, the object of the present invention is to provide a sort of upside-down pump in this field, to the extent that it can address certain technical issues: the pump core assembly of like products that are currently available can hardly maintain pressure, no inner and outer pump body structures in the pump body of the pump core assembly, and poor effect of foam spraying. The above object is attained by the following technical protocol.

An upside-down pump, which comprises a bottle body, a cap and a pump core assembly, the said pump core assembly is disposed on the bottom mouth of the bottle body through a large ring, the cap is disposed at the liquid outflow hole of the pump core assembly, the pump core assembly comprises a pump body, a valve needle, a spring and a piston; wherein the pump body of the said pump core assembly comprises an outer pump body and an inner pump body, the coupling joint of the outer pump body and the inner pump body is provided with a sealing ring and tightened and securely held to the bottle mouth of the bottle body through the large ring, the inner pump body is securely fastened in the outer pump body, the valve stem cavity at one end of the piston extends out of the large ring, the outer diameter of the piston ring at the other end of the piston is sealed against the inner diameter of the inner pump body, the bottom of the center hole of the piston fits with one end of the connecting rod, the inner wall of the center hole of the piston at the coupling joint is provided with a diversion groove, the outer diameter of the other end of the connecting rod fits with the liquid inflow cavity of the inner pump body, a valve needle is disposed in the connecting rod, the needle head at one end of the valve needle is securely fastened to one end of the valve sleeve, the outer diameter of the valve needle and the valve sleeve in the connecting rod is provided with a spring, one end of the spring abuts against the other end of the valve needle in the connecting rod, a floating clearance is disposed between the valve needle in the connecting rod and the center hole of the piston, the other end of the spring abuts against the outer diameter ring rib at the other end of the valve sleeve, a side thru-hole is disposed in the outer diameter ring of the valve sleeve, a second ball is disposed on the inner diameter bottom hole of the inner pump body at the bottom coupling joint of the valve sleeve, the bottom hole of the inner pump body extends from the suction pipe hole on one side of the bottom of the outer pump body and fits with the first thru-hole on one side of the connecting sleeve, an annular clearance is disposed between the outer diameter of the inner pump body at the coupling joint and the inner diameter of the connecting sleeve, the second thru-hole on the other side of the connecting sleeve fits with one end of the upside-down suction pipe, a first ball is disposed at the coupling joint, the other end of the upside-down suction pipe extends to the top inner wall in the bottle body, the bottom joint of the connecting sleeve fits with one side of the base sleeve, a knurled column is disposed at the other end of the base sleeve, the said knurled column of the base sleeve is inserted in the auxiliary hole on the auxiliary hole base sleeve on the other side of the bottom of the outer pump body, protruded to the bottom and a gap is disposed in the hole of the protrusion, and the first thru-hole and the second thru-hole in the bottom cavity at the joint of the connecting sleeve and the base sleeve communicate with each other. Thereby, the outer cover of the large ring can be opened, the valve stem cavity of the piston fits with the liquid outflow hole in the cap cover, so that foam can spray out of the nozzle hole on one side of the cap cover. During regular use of the upside-down pump, the liquid in the bottle can transfer into the outer pump body via the cap at the bottom of the outer pump body, and enter the inner pump body via the annular clearance disposed between the inner pump body and the connecting sleeve. Liquid enters the valve sleeve and the connecting rod via the second ball of the inner pump body, then sprays out of the piston via the floating clearance disposed between the valve needle in the connecting rod and the center hole of the piston; when used in upside-down state, the liquid in bottle will transfer into the inner pump body via the upside-down suction pipe, the connecting sleeve and the base sleeve, the liquid enters the valve sleeve and the connecting rod via the second ball of the inner pump body, then sprays out of the piston via the floating clearance disposed between the valve needle in the connecting rod and the center hole of the piston; the above floating gap is an offset clearance created between parts during vertical shift of the piston, the fitting structure of the inner pump body and the outer pump body as part of the pump body alters the air pressure change passage in the bottle body. When the bottle body increases in length and height, a tee junction can be added with another suction pipe leading to the bottom of the bottle at the joint of the connecting sleeve and the upside-down suction pipe.

The said piston cavity is disposed above the liquid inflow cavity of the inner pump body, the outer diameter of the piston cavity of the inner pump body fits with the inner diameter above the outer pump body, a lower cavity is disposed in the inner cavity where the inner pump body fits with the outer pump body on one side of the auxiliary hole of the inner pump body, a flat key groove is disposed on the outer diameter of the outer pump body on the side that is symmetrical to the lower cavity, and the second thru-hole of the connecting sleeve is disposed in the lower part of the flat key groove of the outer pump body. The above structure is designed with the primary consideration of saving space in the bottle body.

The said upside-down pump is provided an ejector rod that is disposed in the said valve sleeve, with a length greater than the piston stroke. The said ejector rod plays a part in limiting the piston stroke, elastically boosting the recovery of the piston, and causing the valve needle to abut against the second ball via the ejector rod for sealing purpose; this upside-down pump leaves out the ejector rod, or alternatively, achieves the role and purpose of the ejector rod via one end of the needle head extended from the valve needle.

The said diameter of one end of the needle head of the said valve needle is smaller than that of the other end of the piston, one end of the piston of the valve needle gets larger inside out in a tapered form, and the spring abuts against the tapered face of the valve needle. A specific structural embodiment of the valve needle is described above, which can ensure the liquid circulation in the liquid inflow cavity of the inner pump body.

The said diameter of one end of the needle head of the said valve needle is smaller than that of the other end of the piston, one end of the piston of the valve needle gets larger inside out in a tapered form, and the spring abuts against the tapered face of the valve needle. A specific structural embodiment of the valve needle is described above, which can ensure the liquid circulation in the liquid inflow cavity of the inner pump body. cap bushing is disposed in the valve stem cavity on top of the said piston, a screen mesh is disposed at the joint where the valve stem cavity of the piston fits with the cap bushing. The above design facilitates the coupling of the piston to the cap cover via the cap bushing, further disposes the screen mesh and improves the foam spraying effect.

The said outer diameter of the connecting rod underneath the bottom of the said piston is provided with a limiting rib, and four equally spaced edge grooves are disposed on the limiting rib outer diameter of the connecting rod. Thereby, this design facilitates the stroke limiting of the piston rib, protruded ribs are added on the bottom of the piston and of the inner pump body. As a result, the edge grove position can be fixed by the limiting rib to prevent the piston from rotating during use.

The said piston comprises a piston and a valve stem, one end of the valve stem extends out of the large ring, the other end of the valve stem is fastened to the extended end on the other end of the valve needle (9), and a piston is disposed on the outer diameter of the valve needle at the joint. The above structure is a structural embodiment in which the piston combines the piston and the valve stem.

The inner diameter of the pump intake of the said inner pump body is provided with an inner plug, the inner plug is securely fastened on the inner diameter of the pump intake of the inner pump body, and one end of the valve stem extends out of the large ring and the inner plug. The above structure not only facilitates the sealing of the inner pump body at the pump intake, but also securely fastens the inner plug with the pump intakes of the inner pump body and the outer pump body.

The said outer diameter of the one end extending out of the large ring and the inner plug on the said valve stem is provided with a small spring, one end of the said small ring abuts against the inner plug, and the other end of the small spring abuts against the outwardly turned rib on the outer diameter of the valve stem joint. The above structure facilitates the valve stem to deliver the effect of recovery via the small spring.

The said plane of bottle body is provided with a locating platform that is round shaped and protruded, and the groove of the inner wall on one side of the cap bushing fits with the locating platform of the bottle body. The above structure facilitates the fixing orientation of the cap cover during use.

The present invention features reasonable structural design, convenience of production and assembly, extensive applications of the pump core assembly, stable foam spraying, and good injection effect; it can be suitably used for upside-down pump of the foaming pump and the structural improvement of like products thereof.

### DESCRIPTION OF ACCOMPANYING DRAWINGS

FIG. 1 is the schematic view 1 of the cross-sectional structure of the present invention in an upside-down state.

FIG. 2 is the second schematic view 2 of the cross-sectional structure of the present invention in an inverted state.

FIG. 3 is a schematic view of the outer structure of the present invention in an inverted state.

FIG. 4 is a schematic view of the rear structure in the operation state of FIG. 3, and the dotted line as shown is a schematic view of the inner structure of the cap cover.

FIG. 5 is a schematic view of the explosion structure of the present invention, in which the lead-out portion is framed as a schematic view of the bottom structure of the piston.

FIG. 6 is a schematic view of the structure before use of the present invention, and the dotted line as shown is a schematic view of the internal structure, and the lead-out portion is frame as the explosion state of the parts on the bottom of the outer pump body.

FIG. 7 is a schematic structural view of the open state of the base cover on the bottom of the outer pump body of FIG. 6.

FIG. 8 is a schematic view of the cross-sectional structure of the liquid spraying state of FIG. 1, where the arrow as shown is the direction of liquid outflow.

FIG. 9 is a schematic view of the improved cross-sectional structure before use the present invention, where the arrow as shown is the direction of liquid outflow.

Serial number and designation of the accompanying drawings: 1. Bottle body, 101. Locating platform, 2. Outer pump body, 201. Gap, 3. Base cover, 301. Knurled column, 4. Connecting sleeve, 5. First ball, 6. Second ball, 7. Ejector rod, 8. Valve sleeve, 801. Side thru-hole, 9. Valve needle, 10. Spring, 11. Upside-down suction pipe, 12. Connecting rod, 1201. Limiting rib, 13. Piston, 1301. Diversion groove, 1302. Valve stem cavity, 14. Inner pump body, 15. Cap bushing, 16. Outer cover, 17. Large ring, 18. Seal ring, 19, Lower cavity, 20. Cap cover, 21. Piston, 22. Valve stem, 23. Inner plug, 24. Small spring.

### Specific Embodiments

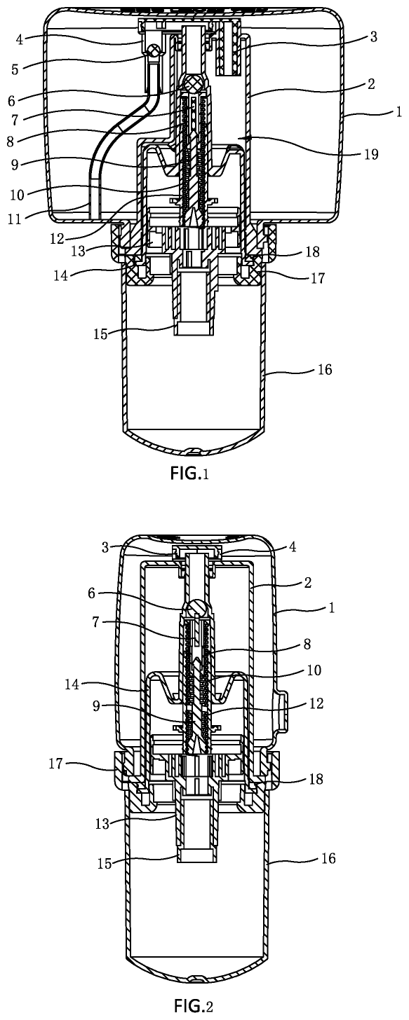

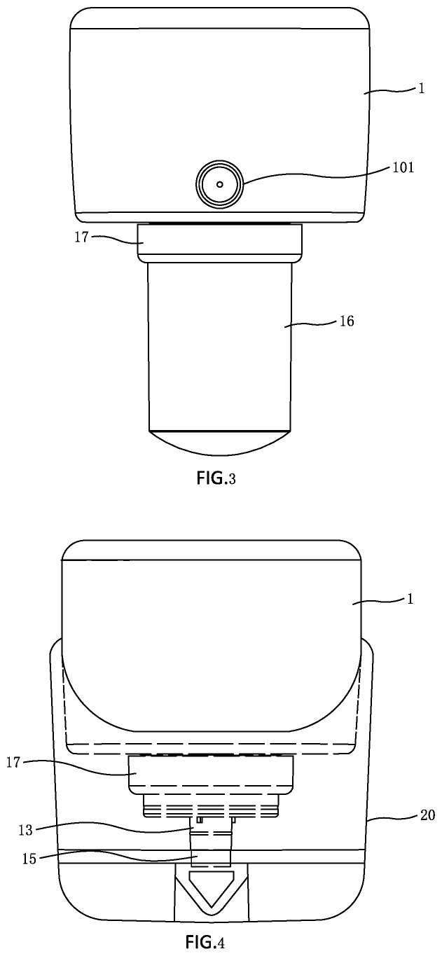

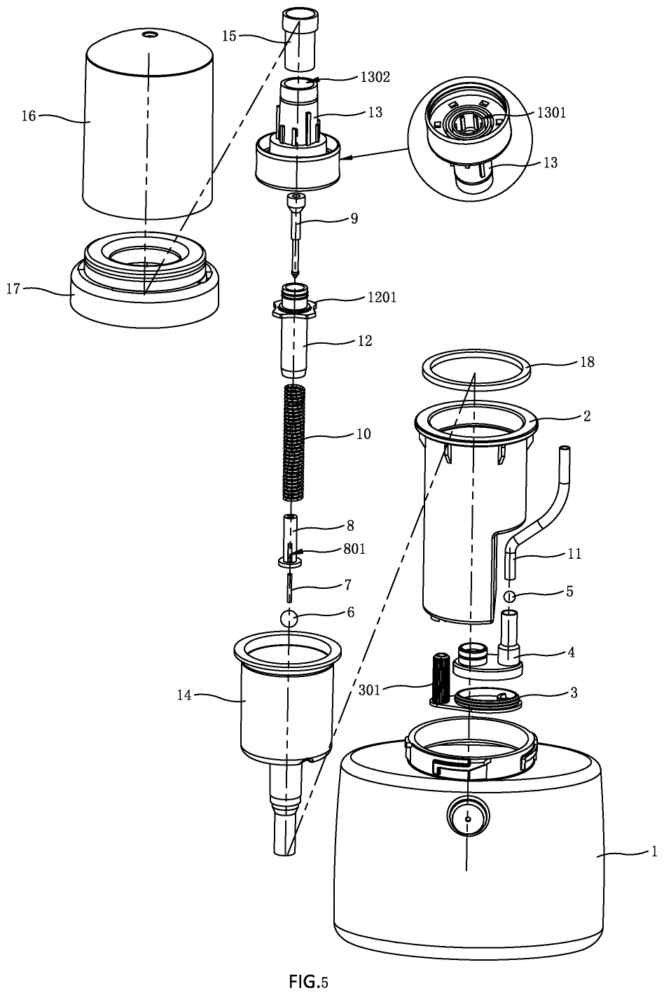

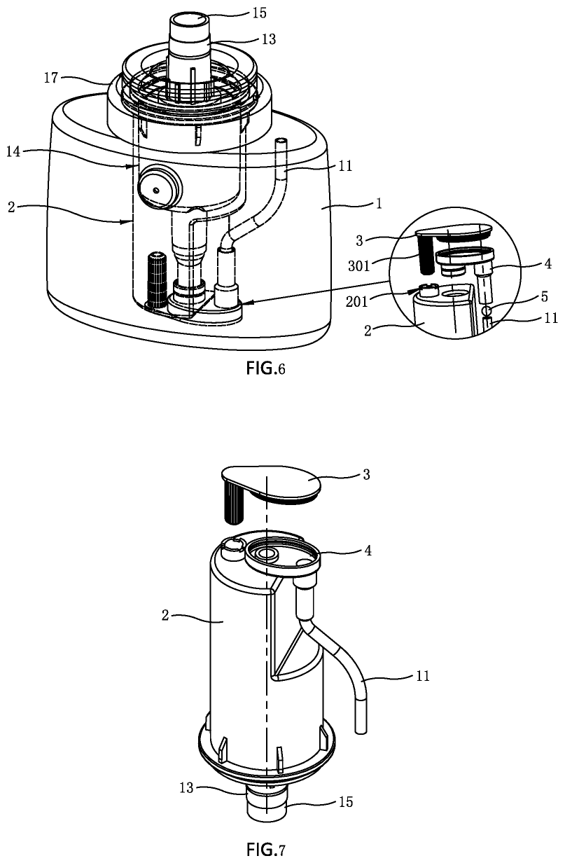

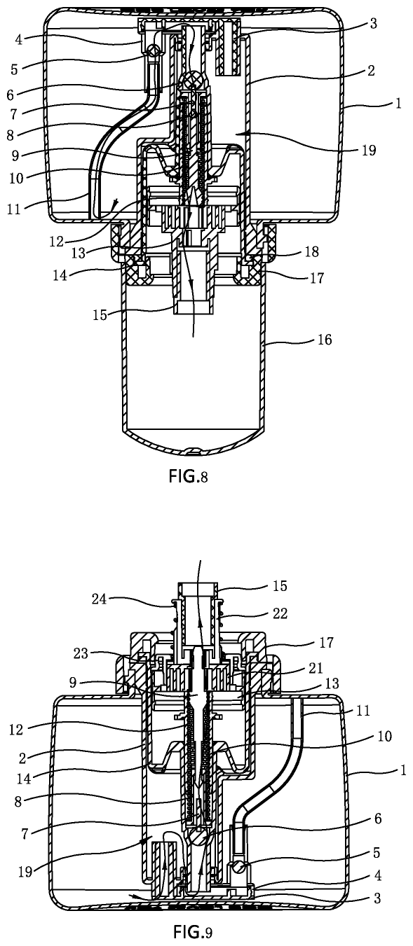

The structure of the present invention will be further described in conjunction with the accompanying drawings. As shown in FIGS.1-8,

An upside-down pump, which comprises a bottle body 1 and a pump core assembly, the pump core assembly comprises a pump body, a valve needle 9, a spring 10 and a piston 13; wherein the pump body of the said pump core assembly comprises an outer pump body 2 and an inner pump body 14, the coupling joint of the outer pump body and the inner pump body is provided with a sealing ring 18 and tightened and securely held to the bottle mouth of the bottle body through the large ring 17, the inner pump body is securely fastened in the outer pump body, the valve stem cavity 1302 at one end of the piston extends out of the large ring, the outer diameter of the piston ring at the other end of the piston is sealed against the inner diameter of the inner pump body, the bottom of the center hole of the piston fits with one end of the connecting rod 12, the inner wall of the center hole of the piston at the coupling joint is provided with a diversion groove 1301, the outer diameter of the other end of the connecting rod fits with the liquid inflow cavity of the inner pump body, a valve needle 9 is disposed in the connecting rod, the needle head at one end of the valve needle is securely fastened to one end of the valve sleeve 8, the outer diameter of the valve needle and the valve sleeve in the connecting rod is provided with a spring 10, one end of the spring abuts against the other end of the valve needle in the connecting rod, a floating clearance is disposed between the valve needle in the connecting rod and the center hole of the piston, the other end of the spring abuts against the outer diameter ring rib at the other end of the valve sleeve, a side thru-hole 801 is disposed in the outer diameter ring of the valve sleeve, a second ball 6 is disposed on the inner diameter bottom hole of the inner pump body at the bottom coupling joint of the valve sleeve, the bottom hole of the inner pump body extends from the suction pipe hole on one side of the bottom of the outer pump body and fits with the first thru-hole on one side of the connecting sleeve 4, an annular clearance is disposed between the outer diameter of the inner pump body at the coupling joint and the inner diameter of the connecting sleeve, the second thru-hole on the other side of the connecting sleeve fits with one end of the upside-down suction pipe 11, a first ball 5 is disposed at the coupling joint, the other end of the upside-down suction pipe extends to the top inner wall in the bottle body, the bottom joint of the connecting sleeve fits with one side of the base sleeve 3, a knurled column 301 is disposed at the other end of the base sleeve, the said knurled column of the base sleeve is inserted in the auxiliary hole on the auxiliary hole base sleeve on the other side of the bottom of the outer pump body, protruded to the bottom and a gap 201 is disposed in the hole of the protrusion, and the first thru-hole and the second thru-hole in the bottom cavity at the joint of the connecting sleeve and the base sleeve communicate with each other, a piston cavity is disposed above the liquid inflow cavity of the inner pump body, the outer diameter of the piston cavity of the inner pump body fits with the inner diameter above the outer pump body. An ejector rod 7 is disposed in the said valve sleeve), with a length greater than the piston stroke; a cap bushing 15 is disposed in the valve stem cavity on top of the piston, the outer diameter of the connecting rod underneath the bottom of the said piston is provided with a limiting rib 1201, four equally spaced edge grooves are disposed on the limiting rib outer diameter of the connecting rod. One side of the said bottle body is provided with a locating platform 101 that is round shaped and protruded, and the groove of the inner wall on one side of the cap cover 20 fits with the locating platform of the bottle body. To use the pump, open the outer cover 16 of the large circle, and the valve stem cavity of the piston piece fits with the liquid outlet hole in the head cap, so that foam can be sprayed from the nozzle hole on one side of the cap cover.

According to the above structural features and referring to FIG. 9, the piston comprises a piston 21 and a valve stem 22, one end of the valve stem extends out of a large circle, the other end of the valve stem is fastened to the extended end on the other end of the valve needle, and a piston is disposed on the outer diameter of the valve needle at the joint. The inner diameter of the pump intake of the said inner pump body is provided with an inner plug 23, the inner plug is securely fastened on the inner diameter of the pump intake of the inner pump body, and one end of the valve stem 22 extends out of the large ring and the inner plug. The outer diameter of the one end extending out of the large ring and the inner plug on the said valve stem is provided with a small spring 24, one end of the said small ring abuts against the inner plug, and the other end of the small spring abuts against the outwardly turned rib on the outer diameter of the valve stem joint. The upside-down pump featuring the above structure can also bring the same technical aim and effect into practice.

1. An upside-down pump, which comprises a bottle body (1), a cap and a pump core assembly, the said pump core assembly is disposed on the bottom mouth of the bottle body through a large ring (17), the cap is disposed at the liquid outflow hole of the pump core assembly, the pump core assembly comprises a pump body, a valve needle (9), a spring (10) and a piston (13); wherein the pump body of the said pump core assembly comprises an outer pump body (2) and an inner pump body (14), the coupling joint of the outer pump body and the inner pump body is provided with a sealing ring (18) and tightened and securely held to the bottle mouth of the bottle body (1) through the large ring (17), the inner pump body is securely fastened in the outer pump body, the valve stem cavity (1302) at one end of the piston (13) extends out of the large ring, the outer diameter of the piston ring at the other end of the piston is sealed against the inner diameter of the inner pump body, the bottom of the center hole of the piston fits with one end of the connecting rod (12), the inner wall of the center hole of the piston at the coupling joint is provided with a diversion groove (1301), the outer diameter of the other end of the connecting rod fits with the liquid inflow cavity of the inner pump body, a valve needle (9) is disposed in the connecting rod, the needle head at one end of the valve needle is securely fastened to one end of the valve sleeve (8), the outer diameter of the valve needle and the valve sleeve in the connecting rod is provided with a spring (10), one end of the spring abuts against the other end of the valve needle in the connecting rod, a floating clearance is disposed between the valve needle in the connecting rod and the center hole of the piston, the other end of the spring abuts against the outer diameter ring rib at the other end of the valve sleeve, a side thru-hole (801) is disposed in the outer diameter ring of the valve sleeve, a second ball (6) is disposed on the inner diameter bottom hole of the inner pump body at the bottom coupling joint of the valve sleeve, the bottom hole of the inner pump body extends from the suction pipe hole on one side of the bottom of the outer pump body and fits with the first thru-hole on one side of the connecting sleeve (4), an annular clearance is disposed between the outer diameter of the inner pump body at the coupling joint and the inner diameter of the connecting sleeve, the second thru-hole on the other side of the connecting sleeve fits with one end of the upside-down suction pipe (11), a first ball (5) is disposed at the coupling joint, the other end of the upside-down suction pipe extends to the top inner wall in the bottle body, the bottom joint of the connecting sleeve fits with one side of the base sleeve (3), a knurled column (301) is disposed at the other end of the base sleeve, the said knurled column of the base sleeve is inserted in the auxiliary hole on the auxiliary hole base sleeve on the other side of the bottom of the outer pump body, protruded to the bottom and a gap (201) is disposed in the hole of the protrusion, and the first thru-hole and the second thru-hole in the bottom cavity at the joint of the connecting sleeve and the base sleeve communicate with each other.

2. The upside-down pump according to claim 1, wherein the piston cavity is disposed above the liquid inflow cavity of the inner pump body (14), the outer diameter of the piston cavity of the inner pump body fits with the inner diameter above the outer pump body (2), a lower cavity (19) is disposed in the inner cavity where the inner pump body fits with the outer pump body on one side of the auxiliary hole of the inner pump body, a flat key groove is disposed on the outer diameter of the outer pump body on the side that is symmetrical to the lower cavity, and the second thru-hole of the connecting sleeve (4) is disposed in the lower part of the flat key groove of the outer pump body.

3. The upside-down pump according to claim 1, wherein the ejector rod (7) is disposed in the said valve sleeve (8), with a length greater than the piston (13) stroke.

4. The upside-down pump according to claim 1, wherein the diameter of one end of the needle head of the said valve needle (9) is smaller than that of the other end of the piston (13), one end of the piston of the valve needle gets larger inside out in a tapered form, and the spring (10) abuts against the tapered face of the valve needle.

5. The upside-down pump according to claim 1, wherein a cap bushing (15) is disposed in the valve stem cavity on top of the said piston (13).

6. The upside-down pump according to claim 1, wherein the outer diameter of the connecting rod (12) underneath the bottom of the said piston (13) is provided with a limiting rib (1201).

7. The upside-down pump according to claim 1, wherein the piston (13) comprises a piston (21) and a valve stem (22), one end of the valve stem extends out of the large ring (17), the other end of the valve stem is fastened to the extended end on the other end of the valve needle (9), and a piston is disposed on the outer diameter of the valve needle at the joint.

8. The upside-down pump according to claim 7, wherein the inner diameter of the pump intake of the said inner pump body (14) is provided with an inner plug (23), the inner plug is securely fastened on the inner diameter of the pump intake of the inner pump body, and one end of the valve stem (22) extends out of the large ring (17) and the inner plug.

9. The upside-down pump according to claim 8, wherein the outer diameter of the one end extending out of the large ring (17) and the inner plug (23) on the said valve stem (22) is provided with a small spring (24), one end of the said small ring abuts against the inner plug, and the other end of the small spring abuts against the outwardly turned rib on the outer diameter of the valve stem joint.

10. The upside-down pump according to claim 1, wherein the plane of bottle body (1) is provided with a locating platform (101) that is round shaped and protruded, and the groove of the inner wall on one side of the cap cover (20) fits with the locating platform of the bottle body.
